(19) United States
(12) Patent Application Publication
(10) Pub. No.: US 2026/0186453 A1
(43) Pub. Date: Jul. 2, 2026

(54) Computer-Implemented Method and System for Anomaly Detection

(71) Applicant: Siemens AG Österreich, Wien (AT)

(72) Inventor: Daniel SCHALL, Hollabrunn (AT)

(21) Appl. No.: 18/867,932

(22) PCT Filed: May 24, 2022
(86) PCT No.: PCT/EP2022/063976

§ 371 Date: Nov. 21, 2024

(51) Int. Cl. G05B 13/02; G06T 7/00

(52) U.S. Cl. CPC G05B 13/027; G06T 7/0004; G06T 2207/20084

(57) ABSTRACT

A computer-implemented method for anomaly detection when controlling a technical device by a controller includes a) providing input data, coding the input data aided by an auto-encoder to form coded data, and decoding the coded data aided by the auto-encoder to form output data, and determining and classifying a reconstruction error, b) determining a target variable from the reconstruction error if the reconstruction error exceeds a predefined reconstruction error threshold, c) providing a model based on artificial intelligence to an evaluator, d) determining, by the evaluator, a prediction for the target variable using the model and the classification of the reconstruction error, and providing the prediction to an analyzer, e) determining, by the analyzer, a rule for improving the reconstruction error from the prediction and a predefined rule set, providing the rule to the controller and controlling, by the controller, the technical device (TD) aide by the rule.

### CROSS-REFERENCE TO RELATED APPLICATIONS

This is a U.S. national stage of application No. PCT/EP2022/063976 filed 24 May 2022

### BACKGROUND OF THE INVENTION

### 1. Field of the Invention

The invention relates to a computer program, an electronically readable data carrier, a data carrier signal, a computer-implemented method, and a system for anomaly detection during the control of a technical device by a controller.

### 2. Description of the Related Art

In factories, systems based on artificial intelligence (AI) are often employed, for example, to detect anomalies in production steps and to initiate corresponding countermeasures to improve the quality of production and to increase efficiency by keeping production downtime to a minimum.

With the frequently employed concept of “black box” AI models, it is difficult or even impossible to explain why an AI came to a particular decision. As a result, trust in AI-based systems is reduced and may prevent people from applying AI further and from making use of its benefits.

This is in particular important for systems that collect data from programmable controllers and perform anomaly detection. In this case, a suitable Al model is an autoencoder, which learns a normal behavior or the good state of a system and detects deviations from the normal behavior during runtime. One indicator of a deviation is what is known as the reconstruction error. If this is high, then it can be assumed that an anomaly is present. This approach is simple but effective. However, a user does not know which interaction of input variables or which relationships between the features led to the high reconstruction error. If, for example the input variables are current, voltage, vibration, temperature, torque, and/or drive speed or pressure, then it is frequently not apparent which state of the variables has influenced the high deviation with regard to the reconstruction error. The reconstruction error is the sum of the deviations between the input variables and the reconstructed output variables. Thus a statement can be made as to which input variables, such as torque or drive speed, are relevant for a high reconstruction error, but not which states of the input variables were decisive, such as high vibration at low temperature and low drive speed.

In the prior art, simpler models are used in parallel with deep learning models, such as decision trees (random forests (RF)), which support excellent interpretability but are less powerful.

On the other hand, the concept of “explainable AI”, (“XA”), is known. Most methods, in this case, indicate in a rather general way which specific areas of the input data are taken into account by the model during the classification.

### SUMMARY OF THE INVENTION

In view of the foregoing, it is therefore an object of the invention to provide a method for applying artificial intelligence which, for example, provides a machine user with improved information about why an error has occurred in a production step and so as to take appropriate countermeasures to reduce or eliminate the error in further production.

In other words, a method is provided that better diagnoses the cause of a detected error in a system based on an autoencoder for anomaly detection and preferably eliminates it automatically and accurately.

These and other objects and advantages are achieved in accordance with the invention by a method comprising:
a) providing input data, by a controller, comprising sensor data that is captured by a sensor at the technical device, at a data input, coding the input data with the aid of an autoencoder to form coded data, and decoding the coded data with the aid of the autoencoder to form output data, and determining and classifying a reconstruction error,
b) determining a target variable from the reconstruction error, if the reconstruction error exceeds a predetermined reconstruction error threshold,
c) providing a model based on artificial intelligence to an evaluation device, where the model has been previously generated and trained with the aid of historical data from reconstruction errors and corresponding input features from the autoencoder,
d) determining by the evaluation device at least one prediction for the target variable and optionally for further variables that depend on the target variable, using the model and the classification of the reconstruction error, and providing the at least one prediction to an analysis device,
e) determining by the analysis device a rule for improving the reconstruction error from the at least one prediction and a predetermined rule set, providing the rule to the controller and controlling by the controller the technical device with the aid of the rule.

This means that the reconstruction error of an autoencoder can easily be analyzed and an accurate cause for the detected error is identified.

The objects and advantages are also achieved in accordance with the invention by a system, comprising a sensor for capturing sensor data relating to the technical device, and a memory for storing historic data, where the system is configured to execute the inventive method.

In an embodiment of the invention, the system is arranged at an edge of a client-server system.

It is advantageous if an efficient method can be executed at the edge of a distributed system, because the availability is higher and communication costs can be reduced. However, an edge computing device usually does not have large computing and memory capacities, which is why only particularly efficient methods can be employed for anomaly detection, such as the inventive method. An example of an EDGE computing device is the SIMATIC IPC847E Industrial Edge Device, manufactured by Siemens. A key feature of such an edge computing device is a processor (CPU, e.g., Intel Xeon E 2278GE) and memory. Other EDGE computing devices are the SIMATIC IPC127E, the SIMATIC IPC227E and the SIMATIC IPC427E, which all include a processor (CPU) and memory.

In an embodiment of the invention, the sensor is a camera and the sensor data is camera images.

The inventive method is particularly efficient in the analysis of images in combination with an autoencoder.

The objects and advantages are also achieved in accordance with the invention by a computer program, comprising commands which, when executed by a computer, cause the computer to execute the inventive method.

The objects and advantages are also achieved in accordance with the invention by an electronically readable data carrier with readable control information stored thereon, which comprises at least the inventive computer program and which is configured such that, when the data carrier is used in a computing device, it performs the inventive method.

The objects and advantages are further achieved by a data carrier signal, which transmits the inventive computer program.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below using an exemplary embodiment shown in the attached drawings, in which:

FIG. 1 shows an exemplary embodiment of the inventive method in a general and simplified form,

FIG. 2 shows the exemplary embodiment of the inventive method in detail; and

FIG. 3 shows an exemplary embodiment of a flow diagram for the inventive method.

### DETAILED DESCRIPTION OF THE EXEMPLARY EMBODIMENTS

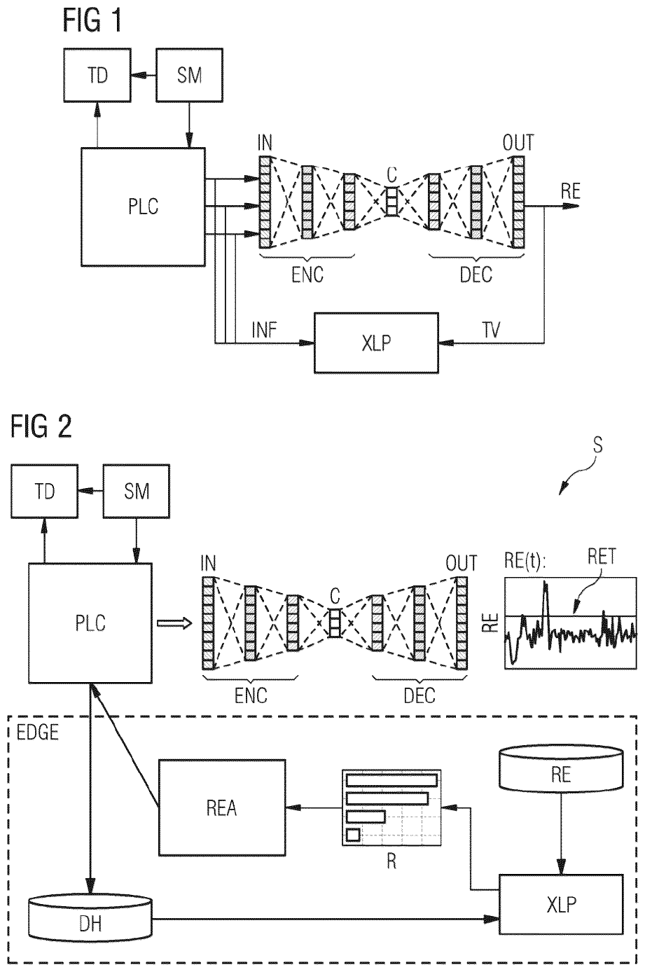

FIG. 1 shows an exemplary embodiment of the inventive method in a general and simplified form.

The method is computer-implemented, i.e., one or more steps can be executed on a computer.

In the method for anomaly detection during the control of a technical device TD by a controller PLC, input data IN is provided by the controller at a data input of an autoencoder. The controller can be an industrial controller, such as a programmable logic controller.

The input data IN comprises sensor data, which is captured by a sensor SM at the technical device TD, for example, image data from a camera, which optically captures the production of products and is employed for an optical inspection of produced products.

The sensor SM is preferably connected to the controller PLC and captures the sensor data that is provided to the autoencoder via the controller PLC.

The autoencoder codes the input data IN to form coded data C with the aid of an encoder COD.

The autoencoder further decodes the coded data C to form output data OUT with the aid of a decoder DEC and also determines a reconstruction error RE.

The reconstruction error RE is assigned predetermined error threshold values, within which a sensor value is or is not permissible.

The reconstruction error RE now serves to detect an anomaly in the input data IN or output data OUT.

The technical device TD is controlled with the aid of the controller PLC.

An evaluation device XLP is now used to determine a prediction for a reconstruction error RE using a model based on artificial intelligence.

The prediction is transmitted to an analysis device REA, which determines a rule for improving the reconstruction error RE from a predetermined rule set. This is intended to cause an improvement in subsequent production, because an error in production has been detected and the cause has been derived therefrom in the form of the prediction, and a corresponding measure to improve the product properties can be initiated with the aid of the controller PLC, because the technical device TD is controlled by controller PLC with the aid of the rule.

FIG. 2 shows the exemplary embodiment in FIG. 1 for the inventive method in detail, comprising:
a) providing input data IN by the controller, comprising sensor data that is captured by a sensor SM at the technical device TD, at a data input, coding the input data IN with the aid of an autoencoder to form coded data C, and decoding the coded data C with the aid of the autoencoder to form output data OUT, and determining and classifying a reconstruction error RE,
b) determining a target variable TV from the reconstruction error RE, if the reconstruction error RE exceeds a predetermined reconstruction error threshold RET,
c) providing a model based on artificial intelligence to an evaluation device XPL, where the model has been previously generated and trained with the aid of historical data DH from reconstruction errors and corresponding input features from the autoencoder,
d) determining by the evaluation device XPL at least one prediction for the target variable TV and optionally for further variables which depend on the target variable TV, using the model, and providing the at least one prediction to an analysis device REA,
e) determining by the analysis device REA a rule for improving the reconstruction error RE from a predetermined rule set, and providing the rule to the controller PLC, and controlling by the controller PLC of the technical device TD with the aid of the rule.

The evaluation device (explainer) XPL is generated and trained with collected, historic input data, which is generated in the autoencoder by its model in order to determine the reconstruction error RE. This can be implemented by random forest regression trees or classification trees.

Regression trees can learn to predict the reconstruction error RE as a target variable based on input variables.

In the case of classification trees, classes (labels) can be predicted based on input variables.

The evaluation device XPL can form these classes by automatically dividing the reconstruction error over a particular period into groups (clusters). These groups can be used to derive the classes, and the input variables with their groups can be used to train classification trees.

Thus the evaluation device XPL supplies information relating to variable importance and interaction between variables.

The information obtained from the evaluation device XPL is now used to define rules that should lead to an improvement in the reconstruction error RE. Such rules can, for example, be a semi-automatic or fully automatic adjustment of operating parameters of the technical device TD, or the performance of a calibration or sensor cleaning.

The analysis device REA can preferably take into account a statistical variable, a relevance R, in the rule selection, with which the prediction can be weighted in individual parameters or features, for example, with the aid of variable importance, a technique for determining which features within a dedicated input vector contribute the most to an output variable of a model.

The analysis device REA is preferably rule-based, but can optionally also use an artificial intelligence model.

The “variable importance” is determined using the previously explained XPL approach. A rule set is defined using rules {“IF ‘condition’ THEN ‘result’”}.

For each rule in the rule set a relevance R is calculated, by determining which input variables have been identified via variable importance and which variables are dealt with in the rule set.

A example of a rule is
{IF ‘vibration’==HIGH AND ‘temperature’==LOW AND ‘drivespeed’==LOW THEN ‘action: drivespeedincrease’}

It is provided that the prediction comprises one or more parameters which depend on the target variable TV.

The figure also shows an exemplary embodiment with a block diagram for an inventive system S.

The system S has a technical device TD.

A controller PLC is further included, which provides sensor data as input data IN.

Here, the controller PLC is connected to a sensor SM, which captures sensor data (relating to the technical device TD) such as image data from a camera, which optically captures the production of products and is employed for an optical inspection of produced products, and provides it to the autoencoder.

The autoencoder is implemented in the computing device EDGE with a memory and a processor, and can further comprise the evaluation device XPL and the analysis device REA.

In addition, the historical data DH, which is formed from input data IN already analyzed by the autoencoder, as well as the model and reconstruction error RE may be processed and stored in the computing device EDGE. The historical data DH provides the basis for the model of the evaluation device XPL in step c) of the method.

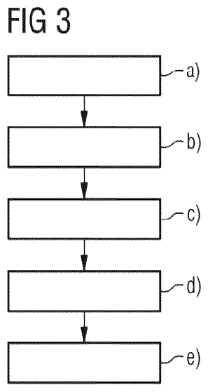

FIG. 3 shows an exemplary embodiment of a flow diagram for the inventive method. The method comprises providing input data, by a controller, comprising sensor data that is captured by a sensor at the technical device, at a data input, coding the input data with the aid of an autoencoder to form coded data, and decoding the coded data with the aid of the autoencoder to form output data, and determining and classifying a reconstruction error, as indicated in step a).

Next, a target variable is determined from the reconstruction error, if the reconstruction error exceeds a predetermined reconstruction error threshold, as indicated in step b).

Next, a model based on artificial intelligence is provided to an evaluation device, as indicated in step c). Here, the model is previously generated and trained with the aid of historical data from reconstruction errors and corresponding input features from the autoencoder.

Next, at least one prediction for the target variable and optionally for further variables that depend on the target variable is determined by the evaluation device, using the model and the classification of the reconstruction error, and the at least one prediction is provided to an analysis device, as indicated in step d).

Next, a rule for improving the reconstruction error from the at least one prediction and a predetermined rule set is determined by the analysis device, the rule is provided to the controller which then controls the technical device with the aid of the rule.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A computer-implemented method for anomaly detection when controlling a technical device via a controller, the method comprising:
a) providing input data by the controller at a data input, coding the input data aided by an autoencoder to form coded data and decoding the coded data aided by the autoencoder to form output data, and determining and classifying a reconstruction error, the input data comprising sensor data which is captured by a sensor at the technical device;
b) determining a target variable from the reconstruction error, if the reconstruction error exceeds a predetermined reconstruction error threshold;
c) providing a model based on artificial intelligence to an evaluator, the model being previously generated and trained aided by historical data from reconstruction errors and corresponding input features from the autoencoder;
d) determining, by the evaluator, at least one prediction for the target variable and optionally for further variables which depend on the target variable, utilizing the model and the classification of the reconstruction error, and providing the at least one prediction to an analyser; and
e) determining, by the analyser, a rule for improving the reconstruction error from the at least one prediction and a predetermined rule set, providing the rule to the controller, and controlling by the controller the technical device aided by the rule.

9. A system for anomaly detection when controlling a technical device by a controller, the system comprising:
a sensor for capturing sensor data relating to the technical device; and
a memory for storing historic data;
wherein the system is configured to:
a) provide input data by the controller at a data input, code the input data aided by an autoencoder to form coded data and decode the coded data aided by the autoencoder to form output data, and determine and classify a reconstruction error, the input data comprising sensor data which is captured by a sensor at the technical device
b) determine a target variable from the reconstruction error, if the reconstruction error exceeds a predetermined reconstruction error threshold;
c) provide a model based on artificial intelligence to an evaluator, the model being previously generated and trained aided by historical data from reconstruction errors and corresponding input features from the autoencoder;
d) determine, by the evaluator, at least one prediction for the target variable and optionally for further variables which depend on the target variable, utilize the model and the classification of the reconstruction error, and provide the at least one prediction to an analyser; and
e) determine, by the analyser, a rule for improving the reconstruction error from the at least one prediction and a predetermined rule set, provide the rule to the controller, and control by the controller the technical device aided by the rule.

10. The system as claimed in claim 8, wherein the system is arranged at an edge of a client-server system.

11. The system as claimed in claim 9, wherein the sensor comprise a camera and the sensor data comprises camera images.

12. The system as claimed in claim 10, wherein the sensor comprise a camera and the sensor data comprises camera images.

13. A computer program, comprising commands which, when executed by a computer, cause the computer to execute the method as claimed in claim 8.

14. An non-transitory electronically readable data carrier encoded with readable control information which, when executed by a computing device, causes anomaly detection when controlling a technical device via a controller, the readable control information comprising:
a) program code for providing input data by the controller at a data input, coding the input data aided by an autoencoder to form coded data and decoding the coded data aided by the autoencoder to form output data, and determining and classifying a reconstruction error, the input data comprising sensor data which is captured by a sensor at the technical device;
b) program code for determining a target variable from the reconstruction error, if the reconstruction error exceeds a predetermined reconstruction error threshold;
c) program code for providing a model based on artificial intelligence to an evaluator, the model being previously generated and trained aided by historical data from reconstruction errors and corresponding input features from the autoencoder;
d) program code for determining, by the evaluator, at least one prediction for the target variable and optionally for further variables which depend on the target variable, utilizing the model and the classification of the reconstruction error, and providing the at least one prediction to an analyser; and
e) program code for determining, by the analyser, a rule for improving the reconstruction error from the at least one prediction and a predetermined rule set, providing the rule to the controller, and controlling by the controller the technical device aided by the rule.

15. A data carrier signal, which transmits the computer program as claimed in claim 12.
